(19) United States
(12) Patent Application Publication
(10) Pub. No.: US 2026/0019720 A1
(43) Pub. Date: Jan. 15, 2026

(54) IMAGE SENSING DEVICE

(71) Applicant: SK hynix Inc., Gyeonggi-do (KR)

(72) Inventor: Hajime SUZUKI, Tokyo (JP)

(21) Appl. No.: 19/258,903

(22) Filed: Jul. 3, 2025

(30) Foreign Application Priority Data
Jul. 9, 2024 (KR) 10-2024-0090576

(51) Int. Cl. H04N 25/42; H04N 25/766; H04N 25/772; H04N 25/78

(52) U.S. Cl. CPC H04N 25/42; H04N 25/766; H04N 25/772; H04N 25/78

(57) ABSTRACT

An image sensing device capable of operating in various modes is disclosed. The image sensing device includes a pixel array configured to generate a pixel signal; a first ramp generator configured to generate a first ramp signal; a second ramp generator configured to generate a second ramp signal; an analog-to-digital converter (ADC) circuit including a comparator configured to compare the pixel signal with one of the first ramp signal and the second ramp signal, and to generate image data based on a result of the comparison; and a processor configured to control the ADC circuit to input the first ramp signal to the comparator in a first mode and to input the second ramp signal to the comparator in a second mode.

### CROSS-REFERENCE TO RELATED APPLICATIONS

The present application claims priority under 35 U.S.C. § 119(a) to Korean patent application number 10-2024-0090576, filed on Jul. 9, 2024, the disclosure of which is incorporated herein by reference in its entirety.

### TECHNICAL FIELD

The technology and implementations disclosed in this patent document generally relate to an image sensing device, and more particularly to an image sensing device capable of operating in various modes.

### BACKGROUND

An image sensing device is a device for capturing optical images by converting light into electrical signals using a photosensitive semiconductor material which reacts to light. With the constant developments in automotive, medical, computer and communication industries, the demand for high-performance image sensing devices has increased in various fields such as smartphones, digital cameras, game machines, Internet of Things (IOT), robots, security cameras and medical micro cameras.

Image sensing devices may be roughly divided into Charge Coupled Device (CCD) image sensing devices and Complementary Metal Oxide Semiconductor (CMOS) image sensing devices. The CCD image sensing devices offer better image quality, but they tend to consume more power and to be larger than the CMOS image sensing devices. The CMOS image sensing devices may be generally smaller in size and consume less power than the CCD image sensing devices. Furthermore, CMOS sensors are fabricated using the CMOS fabrication technology, and thus photosensitive elements and other signal processing circuitry can be integrated into a single chip, enabling the production of miniaturized image sensing devices at a lower cost. For these reasons, CMOS image sensing devices are being developed for many applications including mobile devices.

### SUMMARY

Various embodiments of the present disclosure relate to an image sensing device capable of operating in multiple modes.

Various embodiments of the present disclosure relate to an image sensing device including a reference signal source that consumes less power.

Various embodiments of the present disclosure relate to an image sensing device having a small mounting area by including a reference signal source that uses elements already provided in an analog-to-digital converter (ADC) circuit.

Various embodiments of the present disclosure relate to an image sensing device that generates low-quality images or high-quality images as needed (for example, based upon particular conditions, such as ambient light, motion, etc., that the image sensing device operates in).

In accordance with an embodiment of the present disclosure, an image sensing device may include: a pixel array configured to generate a pixel signal; a first ramp generator configured to generate a first ramp signal; a second ramp generator configured to generate a second ramp signal; an analog-to-digital converter (ADC) circuit including a comparator configured to compare the pixel signal with one of the first ramp signal and the second ramp signal, and to generate image data based on a result of the comparison; and a processor configured to control the ADC circuit to input the first ramp signal to the comparator in a first mode and to input the second ramp signal to the comparator in a second mode.

In some implementations, the ADC circuit may further include: a buffer connected to the first ramp generator and configured to output the first ramp signal based on an enable signal; a first capacitor connected between the buffer and the comparator; a second capacitor connected between the pixel array and the comparator; and a ground switch connected between an output node of the buffer and a ground terminal, and configured to be turned on based on an inverted enable signal having a state opposite to that of the enable signal.

In some implementations, the comparator may include: a first amplifier including a positive(+) input terminal connected to the first capacitor, a negative(−) input terminal connected to the second capacitor, a positive(+) output terminal, and a negative(−) output terminal; a second amplifier connected to the positive(+) output terminal; a first switch connected to the positive(+) input terminal; a second switch connected between the first switch and the negative(−) output terminal; a third switch connected to a first node between the first switch and the second switch and the second ramp generator; a fourth switch connected to the negative(−) input terminal; a fifth switch connected between the fourth switch and the positive(+) output terminal; and a sixth switch connected between a second node between the fourth switch and the fifth switch and the ground terminal.

In some implementations, when the processor operates in the first mode, the processor may be configured to generate the enable signal having a logic high level to activate the buffer and turn off the ground switch, so that the comparator receives the first ramp signal.

In some implementations, when the processor operates in the first mode, the processor may be configured to turn on the first switch, the second switch, the fourth switch, and the fifth switch, and to turn off the third switch and the sixth switch, so that the processor performs auto-zeroing.

In some implementations, when the processor operates in the first mode, the processor may be configured to turn off the first switch, the second switch, the third switch, the fourth switch, the fifth switch, and the sixth switch, so that the processor reads either a reset voltage level of a pixel included in the pixel array or a voltage level of the pixel signal based on an amount of light received by the pixel.

In some implementations, when the processor operates in the second mode, the processor may be configured to generate the enable signal having a logic low level to deactivate the buffer and turn on the ground switch, so that the comparator receives the second ramp signal.

In some implementations, when the processor operates in the second mode, the processor may be configured to turn on the second switch, the fourth switch, and the fifth switch, so that a positive(+) input node of the first amplifier and an output node of the second ramp generator are reset.

In some implementations, when the processor operates in the second mode, the processor may be configured to turn on the fourth switch and the fifth switch, and turn off the second switch and the sixth switch, so that the processor performs auto-zeroing.

In some implementations, when the processor operates in the second mode, the processor may be configured to turn off the second switch, the fourth switch, the fifth switch, and the sixth switch, so that the processor reads either a reset voltage level of a pixel included in the pixel array or a voltage level of the pixel signal based on an amount of light received by the pixel.

In some implementations, the first ramp generator may include a digital-to-analog converter (DAC) configured to output a current.

In some implementations, the second ramp generator may include: a first current source configured to generate a source current; and a second current source configured to generate a sink current.

In some implementations, the image sensing device may further include a first capacitor connected to a positive(+) input terminal of the comparator, wherein the processor may be configured to charge the first capacitor using the first current source and discharge the first capacitor using the second current source.

In some implementations, the image sensing device may further include an interface configured to communicate with an external processor, wherein the processor is configured to: activate the interface in the first mode; and deactivate the interface in the second mode.

In some implementations, in the first mode, the ADC circuit may be configured to transmit the image data to the interface.

In some implementations, in the second mode, the processor may be configured to detect a moving object in an image corresponding to the image data based on the image data.

In some implementations, in the first mode, the processor may be configured to control the ADC circuit to generate the image data corresponding to a full resolution image.

In some implementations, the first ramp signal may be different from the second ramp signal.

In accordance with another embodiment of the present disclosure, an image sensing device may include: a pixel array configured to generate a pixel signal; a comparator configured to compare the pixel signal with one of a first ramp signal and a second ramp signal; a first ramp generator including a digital-to-analog converter and configured to generate the first ramp signal; a second ramp generator including a first current source and a second current source and configured to generate the second ramp signal; a buffer connected to the first ramp generator; a first capacitor connected between the buffer and the comparator; and a second capacitor connected between the pixel array and the comparator.

In some implementations, the comparator may include: a first amplifier including a positive(+) input terminal connected to a first capacitor, a negative(−) input terminal connected to a second capacitor, a positive(+) output terminal, and a negative(−) output terminal; a second amplifier connected to a positive(+) output terminal; a first switch connected to a positive(+) input terminal; a second switch connected between a first switch and a negative(31 ) output terminal; a third switch connected to a first node between a first switch and a second switch and a second ramp generator; a fourth switch connected to a negative(31 ) input terminal; a fifth switch connected between a fourth switch and a positive(+) output terminal; and a sixth switch connected between a second node between a fourth switch and a fifth switch and a ground terminal.

In some implementations, the image sensing device may further include a ground switch connected between an output node of the buffer and the ground terminal.

In accordance with another embodiment of the present disclosure, an image sensing device may include: a pixel array configured to generate a pixel signal; a first ramp generator configured to generate a first ramp signal; a second ramp generator configured to generate a second ramp signal; an analog-to-digital converter (ADC) circuit configured to generate first image data based on the first ramp signal and the pixel signal, and to generate second image data based on the second ramp signal and the pixel signal; and a processor configured to control the ADC circuit so that, in a first mode, the second ramp generator is put to sleep and the ADC circuit receives the first ramp signal, and in a second mode, the first ramp generator is put to sleep and the ADC circuit receives the second ramp signal, wherein a first image corresponding to the first image data has a higher quality than a second image corresponding to the second image data.

It is to be understood that both the foregoing general description and the following detailed description of the present disclosure are illustrative and explanatory and are intended to provide further explanation of the present disclosure as claimed.

### BRIEF DESCRIPTION OF THE DRAWINGS

The above and other features and beneficial aspects of the present disclosure will become readily apparent with reference to the following detailed description when considered in conjunction with the accompanying drawings.

FIG. 1 is a block diagram illustrating an example of an image sensing device according to an embodiment of the present disclosure.

FIG. 2 is a circuit diagram illustrating an example of an image sensing device according to an embodiment of the present disclosure.

FIG. 3 is a circuit diagram illustrating an example of an image sensing device according to an embodiment of the present disclosure.

FIG. 4 is a timing diagram illustrating an example of a method for operating the image sensing device according to an embodiment of the present disclosure.

FIG. 5A is a circuit diagram illustrating an example of the image sensing device according to an embodiment of the present disclosure.

FIG. 5B is a circuit diagram illustrating an example of the image sensing device according to an embodiment of the present disclosure.

FIG. 6 is a timing diagram illustrating an example of a method for operating the image sensing device according to an embodiment of the present disclosure.

FIG. 7A is a circuit diagram illustrating an example of the image sensing device according to an embodiment of the present disclosure.

FIG. 7B is a circuit diagram illustrating an example of the image sensing device according to an embodiment of the present disclosure.

FIG. 7C is a circuit diagram illustrating an example of the image sensing device according to an embodiment of the present disclosure.

FIG. 8 is a block diagram illustrating an example of the image sensing device according to an embodiment of the present disclosure.

FIG. 9 is a diagram illustrating example operations of the image sensing device according to an embodiment of the present disclosure.

FIG. 10 is a block diagram illustrating an example of the image sensing device according to an embodiment of the present disclosure.

FIG. 11 is a diagram illustrating an example of a high-quality image that results from the operations of the image sensing device according to an embodiment of the present disclosure.

### DETAILED DESCRIPTION

The present disclosure provides implementations and examples of an image sensing device capable of operating in various modes that may be used in configurations to substantially address one or more technical or engineering issues and to mitigate limitations or disadvantages encountered in some other image sensing devices. Some implementations of the present disclosure relate to an image sensing device capable of operating in multiple modes. Some implementations of the present disclosure relate to an image sensing device including a reference signal source that consumes less power. Some implementations of the present disclosure relate to an image sensing device having a small mounting area by including a reference signal source that uses elements already provided in an analog-to-digital converter (ADC) circuit. Some implementations of the present disclosure relate to an image sensing device that generates low-quality images or high-quality images as needed. In recognition of the issues above, the present disclosure may provide an image sensing device that generates an image by consuming less power. The present disclosure may provide an image sensing device that generates high-quality images or low-quality images as needed (for example, based on particular conditions, inputs and/or settings). The present disclosure may provide an image sensing device having a small mounting area.

Reference will now be made in detail to the embodiments of the present disclosure, examples of which are illustrated in the accompanying drawings. Wherever possible, the same reference numbers will be used throughout the drawings to refer to the same or like parts. While the present disclosure is susceptible to various modifications and alternative forms, specific embodiments thereof are shown by way of example in the drawings. However, the present disclosure should not be construed as being limited to the embodiments set forth herein.

Hereinafter, various embodiments will be described with reference to the accompanying drawings. However, it should be understood that the present disclosure is not limited to specific embodiments, but includes various modifications, equivalents and/or alternatives of the embodiments. The embodiments of the present disclosure may provide a variety of effects capable of being directly or indirectly recognized through the present disclosure.

Hereinafter, embodiments of the present disclosure will be described in detail with reference to the accompanying drawings so that the present disclosure may be easily realized by those skilled in the art. However, the present disclosure may be achieved in various different forms and is not limited to the embodiments described herein.

In the following description of embodiments of the present disclosure, a detailed description of known functions and configurations incorporated herein will be omitted when it may make the subject matter of the present disclosure rather unclear. In the drawings, parts that are not related to a description of the present disclosure are omitted to clearly explain the present disclosure and similar reference numbers will be used throughout this specification to refer to similar parts.

In the present disclosure, when a component is referred to as being “connected”, “coupled”, or “joined” to another component, it may include not only a direct connection relationship but also an indirect connection relationship in which another component is present therebetween. In addition, when a component “comprises”, “includes” or “has” another component, this means that the component does not exclude other components unless specifically stated above but may further include other components.

In the present disclosure, terms such as “first”, “second”, etc. are used only to distinguish one element from other elements and is not used to limit elements, and unless otherwise specified, it does not limit an order or importance, etc. of elements. Accordingly, within a scope of the present disclosure, a first element in an embodiment may be referred to as a second element in another embodiment and likewise, a second element in an embodiment may be referred to as a first element in another embodiment.

In the following description, components are discriminated from each other to clearly describe their characteristics, but this does not mean that they are necessarily physically separated. That is, a plurality of components may be integrated into one hardware or software module and one component may be divided into a plurality of hardware or software modules. Accordingly, integrated or divided embodiments are within the scope of the present disclosure even if not specifically stated.

In the following description, components described with reference to various embodiments are not all necessarily required and some components may be selectively used. Accordingly, embodiments composed of some of the components described in one embodiment are also within the scope of the present disclosure. Further, embodiments implemented by adding components to various embodiments are also within the scope of the present disclosure.

In the present disclosure expressions of positional relationships used in the present specification such as “top”, “upper”, “bottom”, “lower”, “left”, “right”, etc. are employed for the convenience of explanation, and when the drawings illustrated in the present specification are viewed in reverse, the positional relationships described in the specification may be interpreted in the opposite way.

In the present disclosure, each of phrases such as “A or B”, “at least one of A and B”, “at least one of A or B”, “A, B or C”, “at least one of A, B and C”, “and “at least one of A, B, or C” may include any one or all possible combinations of the items listed together in the corresponding one of the phrases. In description of the present disclosure, the term “and/or” may include a combination of a plurality of items or any one of a plurality of listed items. For example, “A or B” may include “only A”, “only B”, or “both A and B”.

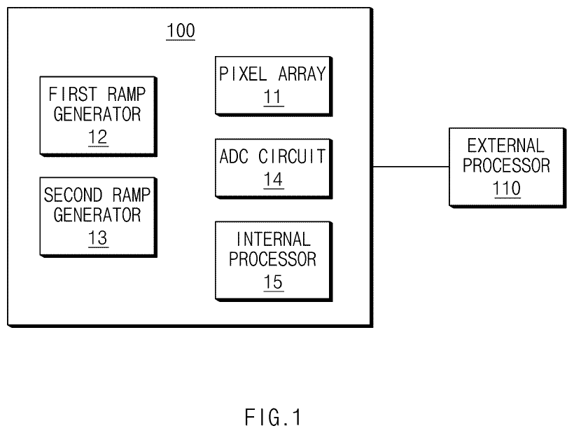

Hereinafter, embodiments of the present disclosure will be specifically described with reference to FIGS. 1 to 11.

FIG. 1 is a block diagram illustrating an example of an image sensing device 100 according to an embodiment of the present disclosure.

Referring to FIG. 1, the image sensing device 100 may include a pixel array 11, a first ramp generator 12, a second ramp generator 13, an analog-to-digital converter (ADC) circuit 14, and an internal processor 15. In addition, the image sensing device 100 may be connected to an external processor 110.

The image sensing device 100 may be a Complementary Metal Oxide Semiconductor Image Sensor (CIS) that converts light into electrical signals, but is not limited thereto.

The image sensing device 100 may operate in various operation modes. For example, the image sensing device 100 may operate in a first mode or a second mode as needed (for example, based on particular inputs, externally sensed environment and/or settings). A first image generated by the image sensing device 100 operating in the first mode may have a higher quality than a second image generated by the image sensing device 100 operating in the second mode. In addition, the image sensing device 100 operating in the second mode may consume less power than when operating in the first mode. In other words, the first mode may be a mode that prioritizes image quality (for example, based on a metric determining the complexity of an image), and the second mode may be a mode that aims to consume less power (for example, based on the battery level falling below a predetermined threshold). In addition, the image sensing device 100 may generate image data corresponding to a full resolution image in the first mode. In addition, the image sensing device 100 may perform motion detection in the second mode. The scope of the operation modes of the image sensing device 100 is not limited to those described above, and the image sensing device 100 may generate an image by adaptively changing the mode to another based upon dynamic, real time or near real time determination of appropriate requirements for the image capture, so that the image sensing device 100 can efficiently use power.

The pixel array 11 may include a plurality of pixels arranged in a two-dimensional (2D) matrix structure (for example, consecutively arranged in a column direction and/or a row direction). In addition, the pixel array 11 may be configured to generate a pixel signal. For example, the pixel array 11 may generate a pixel signal based on incident light applied to each of the plurality of pixels.

The first ramp generator 12 may be configured to generate a first ramp signal.

The second ramp generator 13 may be configured to generate a second ramp signal. The second ramp signal may be different from the first ramp signal.

The first ramp generator 12 and the second ramp generator 13 may be connected to the ADC circuit 14. The first ramp generator 12 may transmit the first ramp signal to the ADC circuit 14, and the second ramp generator 13 may transmit the second ramp signal to the ADC circuit 14.

The first ramp generator 12 may include a digital-to-analog converter (DAC) circuit. Specifically, the first ramp generator 12 may include a DAC circuit that outputs a current. For example, the first ramp generator 12 may include a current DAC with K-bit precision. In addition, the first ramp generator 12 may generate the first ramp signal using not only the DAC outputting the current but also a resistor.

The second ramp generator 13 may include a first current source and a second current source (not shown). The first current source may be configured to generate a source current. In addition, the second current source may be configured to generate a sink current.

The ADC circuit 14 may be configured to generate image data. The ADC circuit 14 may generate image data by performing various signal processing on input signals. For example, the ADC circuit 14 may perform an analog (or hardware) binning operation, a digital (or pixel) binning operation, a correlated double sampling (CDS) operation, noise reduction processing, etc., but is not limited thereto.

The ADC circuit 14 may include a comparator, a buffer, at least one capacitor, and/or a ground switch connected to a ground terminal. More specific details regarding the configuration of the ADC circuit 14 will be described in further detail herein below.

The internal processor 15 may operate in the first mode or the second mode by using one of the plurality of ramp generators (12, 13) based on particular operating conditions. For example, the internal processor 15 may control the ADC circuit 14 so that the first ramp signal is input to a comparator included in the ADC circuit 14 in the first mode. In addition, the internal processor 15 may control the ADC circuit 14 so that the second ramp signal is input to the comparator included in the ADC circuit 14 in the second mode. More specific details regarding a method for controlling the ADC circuit 14 by the internal processor 15 will be described later.

The external processor 110 may determine the mode in which the image sensing device 100 will operate. For example, when a high-quality image is required, the external processor 110 may output a command to the image sensing device 100 to operate in the first mode. Accordingly, the internal processor 15 may operate in the first mode by activating the first ramp generator 12 and deactivating the second ramp generator 13 based on the command. In addition, although not shown in FIG. 1, the internal processor 15 may activate an interface that performs communication with the external processor 110 in the first mode. Accordingly, the ADC circuit 14 may transmit image data corresponding to the high-quality image to the external processor 110 through the interface. In addition, when power consumption needs to be (or is set to be) reduced, the external processor 110 may output a command to the image sensing device 100 to operate in the second mode. Accordingly, the internal processor 15 may deactivate the first ramp generator 12 and activate the second ramp generator 13 based on the command.

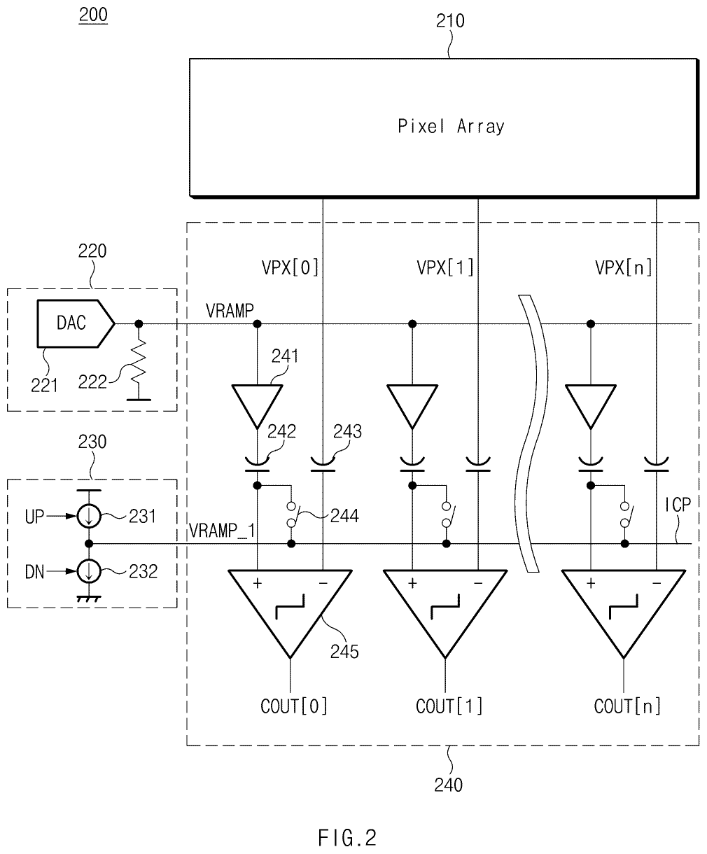

FIG. 2 is a circuit diagram illustrating an example of an image sensing device 200 in accordance with an embodiment of the present disclosure.

Referring to FIG. 2, the image sensing device 200 may include a pixel array 210, a first ramp generator 220, a second ramp generator 230, and an ADC circuit 240. The pixel array 210, the first ramp generator 220, the second ramp generator 230, and the ADC circuit 240 of FIG. 2 may correspond to the pixel array 11, the first ramp generator 12, the second ramp generator 13, and the ADC circuit 14 of FIG. 1, respectively.

The pixel array 210 may generate pixel signals (VPX[0] to VPX[n]). For example, the pixel array 210 may generate pixel signals (VPX[0] to VPX[n]) respectively corresponding to the columns of the pixel array. The pixel signals (VPX[0] to VPX[n]) may be input to the ADC circuit 240 connected to the pixel array 210.

The first ramp generator 220 may include a DAC 221 and a resistor 222. The DAC 221 may represent a DAC that generates a current. A first ramp signal (VRAMP) may be generated by the current generated by the DAC 221 and the resistor 222.

The second ramp generator 230 may include a first current source 231 and a second current source 232. A voltage may be applied to the first current source 231, and the second current source 232 may be connected to a ground terminal. The second ramp generator 230 may generate a second ramp signal (VRAMP_1) using the first current source 231 and the second current source 232. The second ramp signal VRAMP_1 may be a signal corresponding the ratio of current values of the first current source 231 and the second current source 232.

The ADC circuit 240 may include ADCs respectively connected to the columns of the pixel array 210. In addition, the ADC circuit 240 may include a plurality of buffers, a plurality of capacitors, a plurality of switches, and a plurality of comparators. The plurality of comparators may generate comparison signals (COUT[0] to COUT[n]), respectively. Referring to the column to which a pixel signal (VPX[0]) is input, the ADC circuit 240 may include a buffer 241, a first capacitor 242, a second capacitor 243, a switch 244, and a comparator 245. The comparator 245 may generate a comparison signal (COUT[0]) by comparing input signals with each other. For example, the comparator 245 may generate a comparison signal (COUT[0]) by comparing the input first ramp signal (VRAMP) with the pixel signal (VPX[0]) or by comparing the input second ramp signal (VRAMP_1) with the pixel signal (VPX[0]). Specifically, the comparator 245 may generate a comparison signal (COUT[0]) corresponding to a magnitude relationship between the pixel signal (VPX[0]) and one of the first ramp signal (VRAMP) and the second ramp signal (VRAMP_1).

Although not shown in FIG. 2, the ADC circuit 240 may include a counter. The counter may perform counting in synchronization with an edge (e.g., a rising edge or a falling edge) of a clock signal (CLK), and may perform counting until the comparison signal (COUT[0]) transitions from a first level (e.g., a logic high level) to a second level (e.g., a logic low level), so that the counter can output an accumulated count value as pixel data, but is not limited thereto. Image data may be generated by performing signal processing on pixel data, but is not limited thereto.

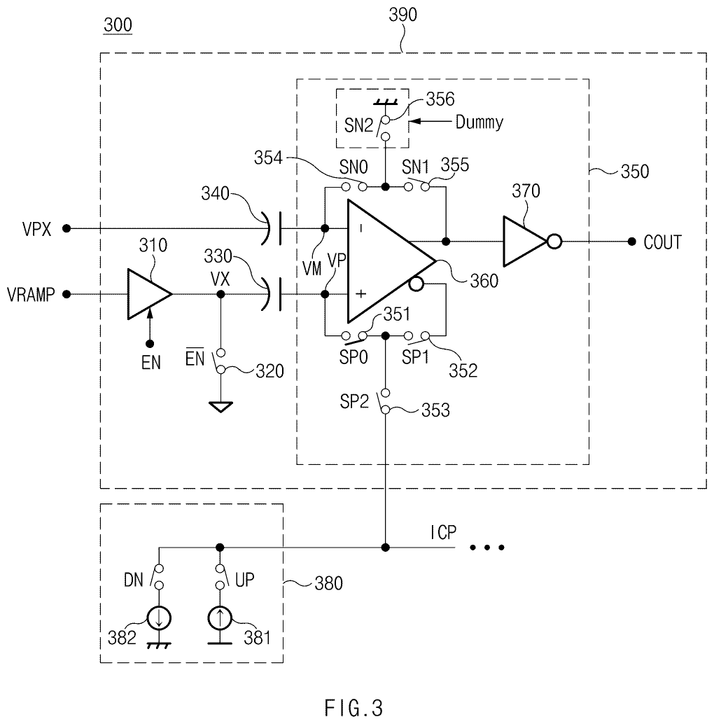

FIG. 3 is a circuit diagram illustrating an example of an image sensing device 300 according to an embodiment of the present disclosure.

Referring to FIG. 3, the image sensing device 300 may include an ADC circuit 390 and a second ramp generator 380. Although not shown in FIG. 3, the image sensing device 300 may also include a first ramp generator configured to generate a first ramp signal (VRAMP) and a pixel array configured to generate a pixel signal (VPX).

The ADC circuit 390 may include a buffer 310, a ground switch 320, a first capacitor 330, a second capacitor 340, and a comparator 350.

The buffer 310 may be configured to be activated according to an enable signal (EN). Specifically, the buffer 310 may be connected to the first ramp generator and configured to output a first ramp signal according to the enable signal (EN). The buffer 310 may be activated when operating in the first mode, thereby suppressing noise introduction to the first ramp signal. Accordingly, the ADC circuit 390 in the first mode may generate image data corresponding to a higher-quality image.

A ground switch 320 may be connected between an output node (VX) of the buffer 310 and a ground terminal. In addition, the ground switch 320 may be configured to be turned on according to an inverted enable signal (EN) having a state opposite to that of the enable signal (EN).

The first capacitor 330 may be connected between the buffer 310 and the comparator 350.

The second capacitor 340 may be connected between the pixel array and the comparator 350.

The comparator 350 may include a first amplifier 360, a second amplifier 370, a first switch (SP0) 351, a second switch (SP1) 352, a third switch (SP2) 353, a fourth switch (SN0) 354, a fifth switch (SN1) 355, and a sixth switch (SN2) 356.

The first amplifier 360 may have a positive(+) input terminal, a negative(−) input terminal, a positive(+) output terminal, and a negative(−) output terminal.

The first capacitor 330 may be connected to the positive(+) input terminal of the first amplifier 360, and the second capacitor 340 may be connected to the negative(−) input terminal of the first amplifier 360.

The second amplifier 370 may be connected to the positive(+) output terminal of the first amplifier 360, and may output a comparison signal (COUT).

The first switch 351 may be connected to the positive(+) input terminal of the first amplifier 360. For example, the first switch 351 may be connected to a VP node between the first capacitor 330 and the positive(+) input terminal of the first amplifier 360.

The second switch 352 may be connected between the first switch 351 and the negative(−) output terminal of the first amplifier 360.

The third switch 353 may be connected to the second ramp generator 380 and a first node between the first switch 351 and the second switch 352.

The fourth switch 354 may be connected to the negative(−) input terminal of the first amplifier 360. For example, the fourth switch 354 may be connected to a VM node between the second capacitor 340 and the negative(−) input terminal of the first amplifier 360.

The fifth switch 355 may be connected between the fourth switch 354 and the positive(+) output terminal of the first amplifier 360.

The sixth switch 356 may be connected between the ground terminal and the second node between the fourth switch 354 and the fifth switch 355.

The second ramp generator 380 may include a first current source 381 and a second current source 382. The second ramp generator 380 may be controlled by a signal (DN) and a signal (UP).

The processor included in the image sensing device 300 may operate in the first mode or the second mode by turning on or off the plurality of switches (320, 351, 352, 353, 354, 355, 356) and then activating or deactivating the buffer 310. For example, the processor may control the plurality of switches (320, 351, 352, 353, 354, 355, 356) and the buffer 310, so that the processor may input the first ramp signal (VRAMP) to the comparator 350 when operating in the first mode and may input the second ramp signal (VRAMP_1) to the comparator 350 when operating in the second mode. More specific details regarding methods for controlling the plurality of switches (320, 351, 352, 353, 354, 355, 356) and the buffer 310 are described herein below.

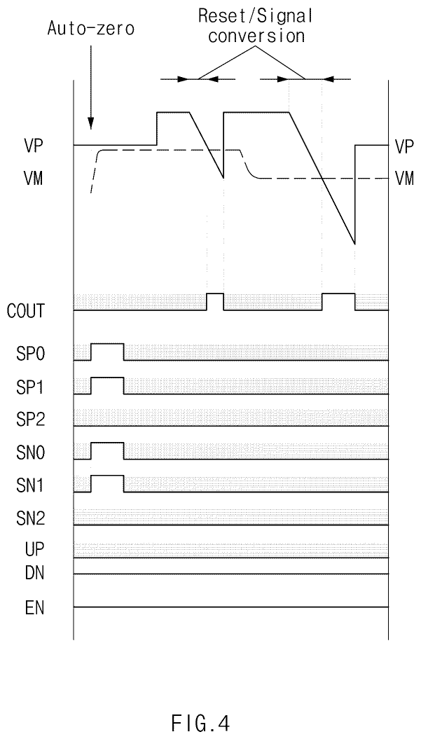

FIG. 4 is a timing diagram illustrating an example of a method for operating the image sensing device according to an embodiment of the present disclosure.

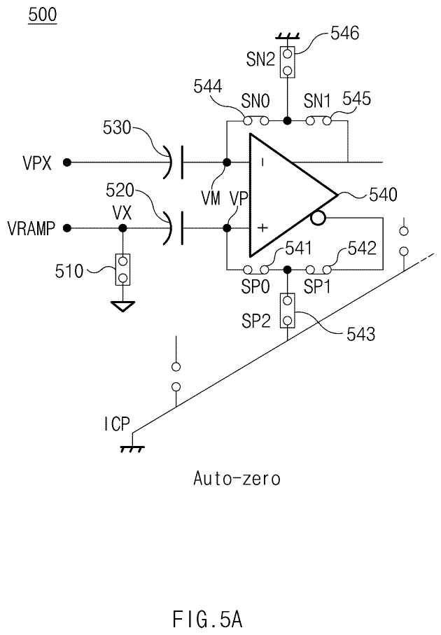

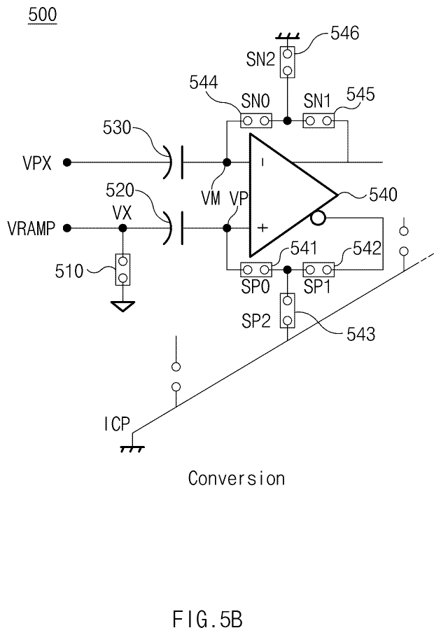

FIG. 5A is a circuit diagram illustrating an example of the image sensing device 500 according to an embodiment of the present disclosure.

FIG. 5B is a circuit diagram illustrating an example of the image sensing device 500 according to an embodiment of the present disclosure.

Hereinafter, the embodiment of FIG. 4 will be described in detail with reference to FIGS. 5A and 5B.

Referring to FIGS. 5A and 5B, the image sensing device 500 may include a ground switch 510, a first capacitor 520, a second capacitor 530, a first amplifier 540, a first switch (SP0) 541, a second switch (SP1) 542, a third switch (SP2) 543, a fourth switch (SN0) 544, a fifth switch (SN1) 545, and a sixth switch (SN2) 546.

Referring to FIG. 4, the processor included in the image sensing device 500 may operate in the first mode. For example, when the processor operates in the first mode, the processor may generate an enable signal (EN) having a logic high level to activate the buffer and turn off the ground switch 510 so that the comparator 540 can receive the first ramp signal (VRAMP). Specifically, the processor may generate the enable signal (EN) having a logic high level to activate the buffer, so that the processor can control the buffer having received the first ramp signal (VRAMP) to output the first ramp signal (VRAMP).

In addition, when the processor operates in the first mode, the processor may turn off the third switch (SP2) 543 and the sixth switch (SN2) 546 in order to prevent an unnecessary input differential component from being generated by the switching operation. Also, when the processor operates in the first mode, the processor may control the second ramp generator to connect the ICP line to a ground node.

The processor may perform auto-zeroing. When the processor operates in the first mode, the processor may perform auto-zeroing by turning on the first switch (SP0) 541, the second switch (SP1) 542, the fourth switch (SN0) 544, and the fifth switch (SN1) 545, and turning off the third switch (SP2) 543 and the sixth switch (SN2) 546. A self-bias voltage of the first amplifier 540, which appears at the node (VM), can be maintained at the first capacitor 520, and a self-bias voltage of the first amplifier 540, which appears at the node (VP), can be maintained at the second capacitor 530.

The processor may read a reset voltage level of the pixel included in the pixel array or may read a voltage level of the pixel signal according to the amount of light received by the pixel. For example, when the processor operates in the first mode, the processor may turn off the first switch (SP0) 541, the second switch (SP1) 542, the third switch (SP2) 543, the fourth switch (SN0) 544, the fifth switch (SN1) 545, and the sixth switch (SN2) 546, so that the processor can read the reset voltage level of the pixel included in the pixel array or can read the voltage level of the pixel signal (VPX) according to the amount of light received by the pixel. Specifically, when auto-zeroing is completed, the processor may further increase the voltage level of the first ramp signal (VRAMP) by the offset voltage level using the first ramp generator. In addition, as shown in FIG. 4, a time point at which the voltage level of the pixel signal (VPX) is equal to the voltage level of the first ramp signal (VRAMP) may occur when a first ramp waveform is initiated. The processor may obtain a digital value according to the reset voltage level of the pixel by quantizing the time at which the comparator outputs the comparison signal (COUT) when the voltage level of the pixel signal (VPX) and the voltage level of the first ramp signal (VRAMP) are equal to each other. That is, the processor may read the reset voltage level of the pixel.

The voltage level of the pixel signal (VPX) may change according to the amount of light received by the pixel. After reading the reset voltage level of the pixel, the processor may read the voltage level of the changed pixel signal (VPX). For example, as shown in FIG. 4, the voltage level of the changed pixel signal (VPX) may coincide with the voltage level of the first ramp signal (VRAMP) when the second ramp waveform is initiated. As a result, the processor may obtain a digital value for the voltage level of the pixel signal (VPX) by quantizing the time at which the comparator outputs the comparison signal (COUT). That is, the processor may read the voltage level of the pixel signal (VPX) according to the amount of light received by the pixel.

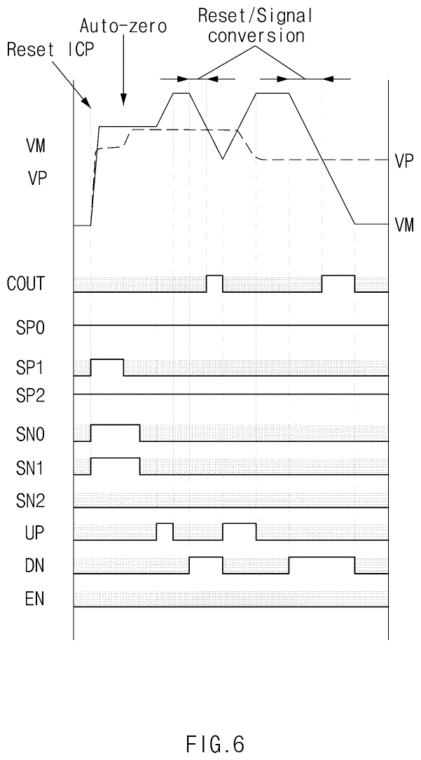

FIG. 6 is a timing diagram illustrating an example of a method for operating the image sensing device according to an embodiment of the present disclosure.

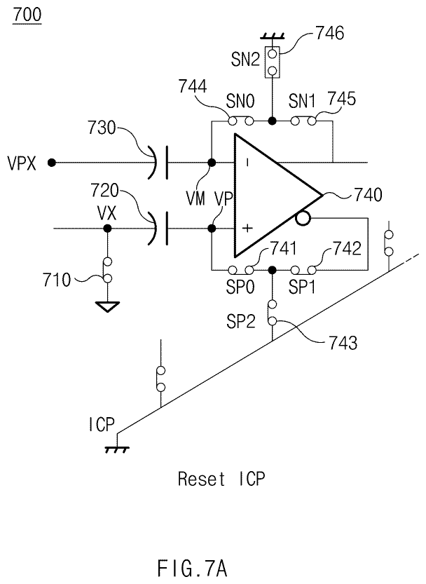

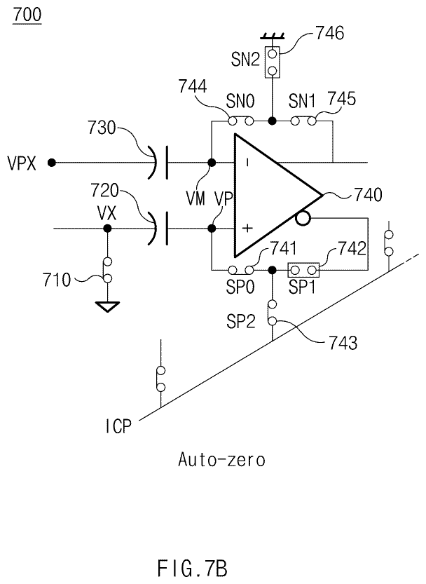

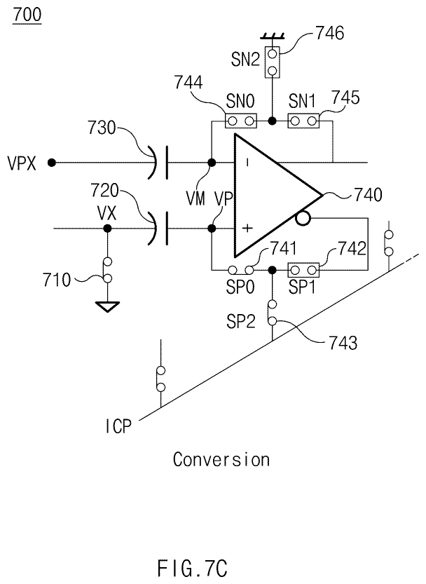

FIG. 7A is a circuit diagram illustrating an example of the image sensing device 700 according to an embodiment of the present disclosure.

FIG. 7B is a circuit diagram illustrating an example of the image sensing device 700 according to an embodiment of the present disclosure.

FIG. 7C is a circuit diagram illustrating an example of the image sensing device 700 according to an embodiment of the present disclosure.

Hereinafter, the embodiment of FIG. 6 will be described in detail with reference to FIGS. 7A to 7C.

Referring to FIGS. 7A to 7C, the image sensing device 700 may include a ground switch 710, a first capacitor 720, a second capacitor 730, a first amplifier 740, a first switch (SP0) 741, a second switch (SP1) 742, a third switch (SP2) 743, a fourth switch (SN0) 744, a fifth switch (SN1) 745, and a sixth switch (SN2) 746.

Referring to FIG. 6, a processor included in the image sensing device 700 may operate in the second mode. For example, when the processor operates in the second mode, the processor may generate an enable signal (EN) having a logic low level to deactivate the buffer, may turn on the ground switch 710, and may turn on the first switch (SP0) 741 and the third switch (SP2) 743 so that the comparator 740 can receive the second ramp signal (VRAMP_1). Specifically, the processor may generate an enable signal (EN) having a logic low level to power down the buffer, may turn on the ground switch 710 to ground the node (VX), and may turn on the first switch (SP0) 741 and the third switch (SP2) 743 to input the second ramp signal (VRAMP_1) to the comparator 740. In the second mode, since the buffer can be powered down, the image sensing device 700 may reduce power consumption. In addition, the processor may turn off the sixth switch (SN2) 746 when operating in the second mode.

In the second mode, since the IV (current-voltage) conversion by the second ramp generator does not require additional components and utilizes the first capacitor 720 already provided in the ADC circuit, the image sensing device 700 may be implemented with a small mounting area.

When the processor operates in the second mode, the processor may reset the output node (e.g., ICP line) and the node (e.g., VP) of the second ramp generator. For example, the processor may reset the node (VP) and the ICP line (for example, RESET ICP, as shown with respect to FIG. 7A) by turning on the second switch (SP1) 742, the fourth switch (SN0) 744, and the fifth switch (SN1) 745. Specifically, the node (VP) and the ICP line may be reset to the average value of the self-bias voltage generated by the first amplifier 740.

When the processor operates in the second mode, the processor may perform auto-zeroing after the node (VP) and the ICP line are reset. For example, when the processor operates in the second mode, the processor may perform auto-zeroing (for example, Auto-zero, as shown with respect to FIG. 7B) by turning on the first switch (SP0) 741, the third switch (SP2) 743, the fourth switch (SN0) 744, and the fifth switch (SN1) 745, and turning off the second switch (SP1) 742 and the sixth switch (SN2) 746. By opening the second switch (SP1) 742, feedback of the signal output from the negative output terminal and feedback of the signal output from the positive input terminal may be blocked, and a potential maintained at the node (VP) may be copied to the node (VM) through such feedback of the signals output from the positive output terminal and the negative output terminal.

In addition, the processor may read the reset voltage level of the pixel included in the pixel array or may read the voltage level of the pixel signal according to the amount of light received by the pixel. For example, when the processor operates in the second mode, the processor may perform conversion (for example, Conversion, as shown with respect to FIG. 7C) by turning on the first switch (SP0) 741 and the third switch (SP2) 743, and may turn off the second switch (SP1) 742, the fourth switch (SN0) 744, the fifth switch (SN1) (745), and the sixth switch (SN2) (746), so that the processor may read the reset voltage level of the pixel included in the pixel array or may read the voltage level of the pixel signal (VPX) according to the amount of light received by the pixel. Here, conversion may mean an operation to obtain a digital value for the voltage level of the pixel signal (VPX).Specifically, when auto-zeroing is completed, the processor may further increase the voltage level of the second ramp signal (VRAMP_1) by the offset voltage level using the second ramp generator. For example, when the UP signal of a logic high level is input to the second ramp generator, the voltage level of the second ramp signal (VRAMP_1) to be input to the first amplifier 740 may increase by a source current applied to the first capacitor 720. In addition, when the voltage level of the second ramp signal (VRAMP_1) reaches a target value, the processor may fix the voltage level of the second ramp signal (VRAMP_1) to be input to the first amplifier 740 by stopping applying the source current to the first capacitor 720 using the UP signal of a logic low level. In addition, when the sink current discharges the first capacitor 720 due to the DN signal of a logic high level, a first ramp waveform may be initiated. The processor may obtain a digital value according to the reset voltage level of the pixel by quantizing the time at which the comparator outputs the comparison signal (COUT) when the voltage level of the pixel signal (VPX) and the voltage level of the second ramp signal (VRAMP_1) are equal to each other. That is, the processor may read the reset voltage level of the pixel.

The voltage level of the pixel signal (VPX) may change according to the amount of light received by the pixel. After the processor reads the reset voltage level of the pixel, the processor may read the voltage level of the changed pixel signal (VPX). For example, as shown in FIG. 6, after the reset voltage level reading of the pixel is completed, the processor may stop applying the sink current to the first capacitor 720 using the DN signal and may output the source current to the first capacitor 720 using the UP signal, thereby returning the potential of each of the node (VP) and the ICP line to an offset level. Accordingly, the voltage level of the changed pixel signal (VPX) and the voltage level of the second ramp signal (VRAMP_1) may coincide with each other, and the processor may obtain a digital value for the voltage level of the pixel signal (VPX) by quantizing the time at which the comparator outputs the comparison signal (COUT). That is, the processor may read the voltage level of the pixel signal (VPX) according to the amount of light received by the pixel.

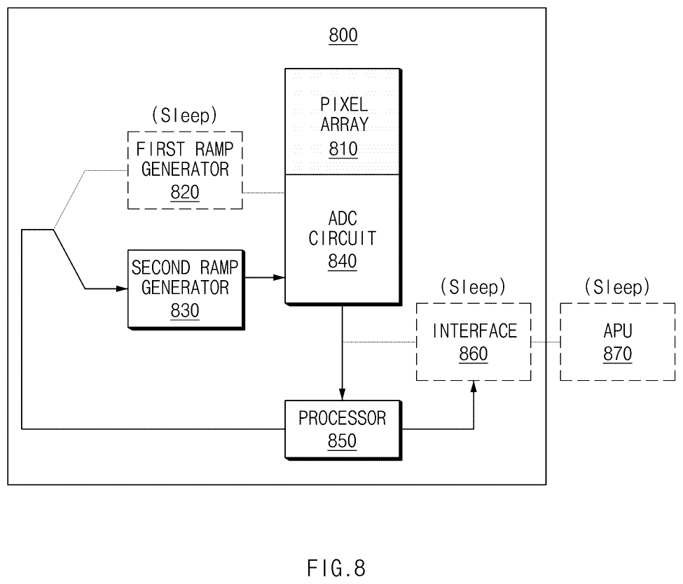

When the voltage level reading of the pixel signal (VPX) is completed, the potential of each of the node (VP) and the ICP line can be maintained until the second switch (SP1) 742, the fourth switch (SN0) 744, and the sixth switch (SN2) 746 are turned on in the next period. FIG. 8 is a block diagram illustrating an example of the image sensing device 800 according to an embodiment of the present disclosure.

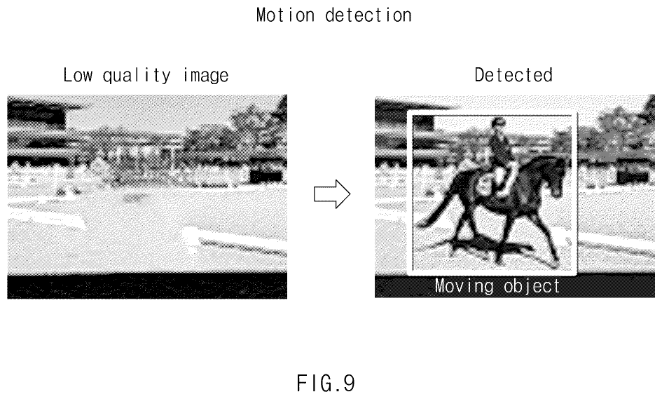

FIG. 9 is a diagram illustrating example operations of the image sensing device 800 according to an embodiment of the present disclosure.

Hereinafter, the embodiment of FIG. 8 will be described in detail with reference to FIG. 9.

Referring to FIG. 8, the image sensing device 800 may include a pixel array 810, a first ramp generator 820, a second ramp generator 830, an ADC circuit 840, a processor 850, and an interface 860, and may communicate with an application processing unit (APU) 870. Here, the APU may also be referred to as an external processor. The image sensing device 800, the pixel array 810, the first ramp generator 820, the second ramp generator 830, the ADC circuit 840, and the processor 850 of FIG. 8 may correspond to the image sensing device 100, the pixel array 11, the first ramp generator 12, the second ramp generator 13, the ADC circuit 14, and the internal processor 15 of FIG. 1, respectively.

The processor 850 may input the second ramp signal of the second ramp generator 830 to the ADC circuit 840 in the second mode. The ADC circuit 840 may generate second image data based on the second ramp signal. When the processor 850 operates in the second mode, the processor 850 may detect a moving object in an image corresponding to the second image data based on the second image data. In other words, the processor 850 may perform motion detection. For example, as illustrated in FIG. 9 by way of non-limiting example, the ADC circuit 840 may generate second image data corresponding to a relatively low-quality second image, and the processor 850 may detect a moving object by performing motion detection based on the second image data.

In addition, when the processor 850 operates in the second mode, the first ramp generator 820 and the interface 860 may enter a sleep mode. That is, when the processor 850 operates in the second mode, the processor 850 may deactivate the interface 860.

Since the first ramp generator 820 and the interface 860 are deactivated in the second mode, the image sensing device 800 may reduce power consumption.

The interface 860 may communicate with the APU 870. The processor 850 may activate the interface 860 when operating in the first mode, and may deactivate the interface 860 when operating in the second mode. As the interface 860 is deactivated, the APU 870 may sleep. The interface 860 may be, for example, a high-speed serial interface (HSSI), but is not limited thereto.

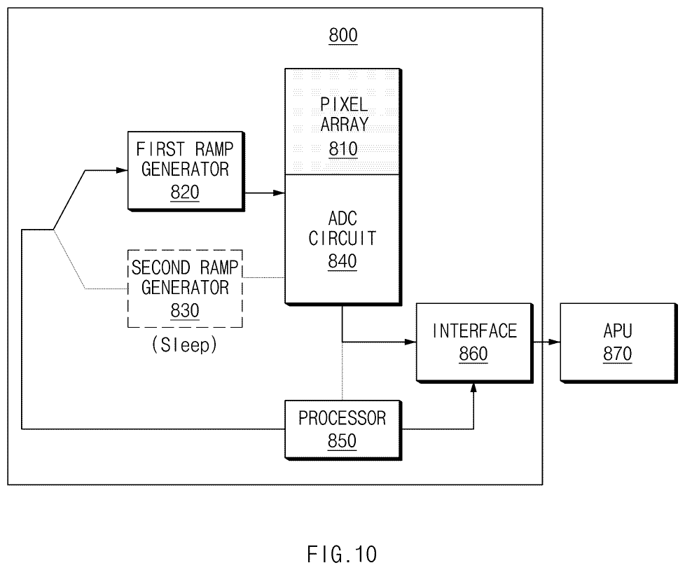

The APU 870 may determine the mode in which the image sensing device 800 will operate. For example, when power consumption needs to be reduced, the APU 870 may issue a command to the image sensing device 800 to operate in the second mode. FIG. 10 is a block diagram illustrating an example of the image sensing device 800 according to an embodiment of the present disclosure.

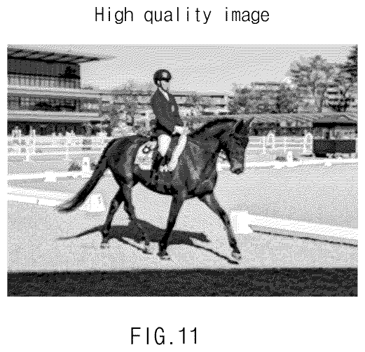

FIG. 11 is a diagram illustrating an example of a high-quality image that results from the operations of the image sensing device 800 based on some embodiments of the present disclosure.

Hereinafter, the embodiment of FIG. 10 will be described in detail with reference to FIG. 11.

Referring to FIG. 10, the image sensing device 800 may include a pixel array 810, a first ramp generator 820, a second ramp generator 830, an ADC circuit 840, a processor 850, and an interface 860, and may communicate with an application processing unit (APU) 870. Here, the APU may also be referred to as an external processor. The image sensing device 800, the pixel array 810, the first ramp generator 820, the second ramp generator 830, the ADC circuit 840, and the processor 850 of FIG. 10 may correspond to the image sensing device 100, the pixel array 11, the first ramp generator 12, the second ramp generator 13, the ADC circuit 14, and the internal processor 15 of FIG. 1, respectively.

The processor 850 may input the first ramp signal of the first ramp generator 820 to the ADC circuit 840 in the first mode. The ADC circuit 840 may generate first image data based on the first ramp signal. As shown in FIG. 11, when the processor operates in the first mode, the first image based on the first image data may have a higher quality than the second image corresponding to the second image data (shown in FIG. 9).

In addition, the processor 850 may put the second ramp generator 830 to sleep when operating in the first mode. For example, the processor 850 may control the ADC circuit 840 so that the second ramp signal generated by the second ramp generator 830 is not input to the ADC circuit 840.

The interface 860 may communicate with the APU 870. The processor 850 may activate the interface 860 when operating in the first mode, and may deactivate the interface 860 when operating in the second mode. The ADC circuit 840 may transmit the first image data to the interface 860 when operating in the first mode. The interface 860 may be, for example, a high-speed serial interface (HSSI), but is not limited thereto.

The APU 870 may determine the mode in which the image sensing device 800 will operate. For example, when a high-quality image is required, the APU 870 may command the image sensing device 800 to operate in the first mode.

As is apparent from the above description, the image sensing device based on some embodiments of the present disclosure may operate in multiple modes.

The image sensing device based on some embodiments of the present disclosure may generate an image by consuming less power.

The image sensing device based on some embodiments of the present disclosure may generate high-quality images or low-quality images as needed.

The image sensing device based on some embodiments of the present disclosure may have a small mounting area.

The embodiments of the present disclosure may provide a variety of effects capable of being directly or indirectly recognized through the above-mentioned patent document.

Those skilled in the art will appreciate that the present disclosure may be carried out in other specific ways than those set forth herein. In addition, claims that are not explicitly presented in the appended claims may be presented in combination as an embodiment or included as a new claim by a subsequent amendment after the application is filed.

The above description merely provides an illustrative explanation of the present disclosure. Accordingly, a person of ordinary skill in the art to which the present disclosure pertains can make various modifications and variations without departing from the essential characteristics of the present disclosure. In addition, the embodiments disclosed in the present disclosure are not intended to limit the scope of the present disclosure but rather to explain it. Therefore, the scope of the present disclosure should not be limited by the embodiments. The scope of protection of this disclosure shall be construed by the appended claims, and all technical spirits within an equivalent scope shall be construed to be included within the scope of this disclosure.

What is claimed is:

1. An image sensing device comprising:
a pixel array configured to generate a pixel signal;
a first ramp generator configured to generate a first ramp signal;
a second ramp generator configured to generate a second ramp signal;
an analog-to-digital converter (ADC) circuit including a comparator configured to compare the pixel signal with one of the first ramp signal and the second ramp signal, and to generate image data based on a result of the comparison; and
a processor configured to control the ADC circuit to input the first ramp signal to the comparator in a first mode and to input the second ramp signal to the comparator in a second mode.

2. The image sensing device according to claim 1, wherein the ADC circuit further includes:
a buffer connected to the first ramp generator and configured to output the first ramp signal based on an enable signal;
a first capacitor connected between the buffer and the comparator;
a second capacitor connected between the pixel array and the comparator; and
a ground switch connected between an output node of the buffer and a ground terminal, and configured to be turned on based on an inverted enable signal having a state opposite to that of the enable signal.

3. The image sensing device according to claim 2, wherein the comparator includes:
a first amplifier including a positive(+) input terminal connected to the first capacitor, a negative(−) input terminal connected to the second capacitor, a positive(+) output terminal, and a negative(−) output terminal;
a second amplifier connected to the positive(+) output terminal;
a first switch connected to the positive(+) input terminal;
a second switch connected between the first switch and the negative(−) output terminal;
a third switch connected to a first node between the first switch and the second switch and the second ramp generator;
a fourth switch connected to the negative(−) input terminal;
a fifth switch connected between the fourth switch and the positive(+) output terminal; and
a sixth switch connected between a second node between the fourth switch and the fifth switch and the ground terminal.

4. The image sensing device according to claim 3, wherein:
in the first mode, the processor is configured to generate the enable signal having a logic high level to activate the buffer and turn off the ground switch, so that the comparator receives the first ramp signal.

5. The image sensing device according to claim 4, wherein:
in the first mode, the processor is configured to turn on the first switch, the second switch, the fourth switch, and the fifth switch, and turn off the third switch and the sixth switch, so that the processor performs auto-zeroing.

6. The image sensing device according to claim 4, wherein:
in the first mode, the processor is configured to turn off the first switch, the second switch, the third switch, the fourth switch, the fifth switch, and the sixth switch, so that the processor reads either a reset voltage level of a pixel included in the pixel array or a voltage level of the pixel signal based on an amount of light received by the pixel.

7. The image sensing device according to claim 3, wherein:
in the second mode, the processor is configured to generate the enable signal having a logic low level to deactivate the buffer and turn on the ground switch, so that the comparator receives the second ramp signal.

8. The image sensing device according to claim 7, wherein:
in the second mode, the processor is configured to turn on the second switch, the fourth switch, and the fifth switch, so that a positive(+) input node of the first amplifier and an output node of the second ramp generator are reset.

9. The image sensing device according to claim 7, wherein:
in the second mode, the processor is configured to turn on the fourth switch and the fifth switch, and turn off the second switch and the sixth switch, so that the processor performs auto-zeroing.

10. The image sensing device according to claim 7, wherein:
in the second mode, the processor is configured to turn off the second switch, the fourth switch, the fifth switch, and the sixth switch, so that the processor reads either a reset voltage level of a pixel included in the pixel array or a voltage level of the pixel signal based on an amount of light received by the pixel.

11. The image sensing device according to claim 1, wherein the first ramp generator includes:
a digital-to-analog converter (DAC) configured to output a current.

12. The image sensing device according to claim 1, wherein the second ramp generator includes:
a first current source configured to generate a source current; and
a second current source configured to generate a sink current.

13. The image sensing device according to claim 12, further comprising:
a first capacitor connected to a positive(+) input terminal of the comparator,
wherein
the processor is configured to charge the first capacitor using the first current source and discharge the first capacitor using the second current source.

14. The image sensing device according to claim 1, further comprising:
an interface configured to communicate with an external processor,
wherein the processor is configured to:
activate the interface in the first mode; and
deactivate the interface in the second mode.

15. The image sensing device according to claim 14, wherein the ADC circuit is configured to:
transmit the image data to the interface in the first mode.

16. The image sensing device according to claim 1, wherein the processor is configured to:
detect a moving object in an image corresponding to the image data based on the image data in the second mode.

17. The image sensing device according to claim 1, wherein the processor is configured to:
control the ADC circuit to generate the image data corresponding to a full resolution image in the first mode.

18. The image sensing device according to claim 1, wherein:
the first ramp signal is different from the second ramp signal.

19. An image sensing device comprising:
a pixel array configured to generate a pixel signal;
a comparator configured to compare the pixel signal with one of a first ramp signal and a second ramp signal;
a first ramp generator including a digital-to-analog converter and configured to generate the first ramp signal;
a second ramp generator including a first current source and a second current source and configured to generate the second ramp signal;
a buffer connected to the first ramp generator;
a first capacitor connected between the buffer and the comparator; and
a second capacitor connected between the pixel array and the comparator.

20. An image sensing device comprising:
a pixel array configured to generate a pixel signal;
a first ramp generator configured to generate a first ramp signal;
a second ramp generator configured to generate a second ramp signal;
an analog-to-digital converter (ADC) circuit configured to generate first image data based on the first ramp signal and the pixel signal, and to generate second image data based on the second ramp signal and the pixel signal; and
a processor configured to control the ADC circuit so that,
in a first mode, the second ramp generator is put to sleep and the ADC circuit receives the first ramp signal, and
in a second mode, the first ramp generator is put to sleep and the ADC circuit receives the second ramp signal,
wherein
a first image corresponding to the first image data has a higher quality than a second image corresponding to the second image data.
